(19) United States
(12) Patent Application Publication
(10) Pub. No.: US 2026/0246730 A1
(43) Pub. Date: Aug. 20, 2026

(54) SHARING MULTICAST SOURCE INFORMATION AMONG VIRTUAL ROUTING AND FORWARDINGS

(71) Applicant: HEWLETT PACKARD ENTERPRISE DEVELOPMENT LP, Spring, TX (US)

(72) Inventors: Tathagata Nandy, Bangalore (IN); Anil Raj, Bangalore (IN); Nilay Tripathi, Bangalore (IN)

(21) Appl. No.: 19/187,446

(22) Filed: Apr. 23, 2025

(30) Foreign Application Priority Data
Feb. 18, 2025 (IN) 202541013828

(51) Int. Cl. H04L 45/16; H04L 12/18; H04L 45/586

(52) U.S. Cl. CPC H04L 45/16; H04L 12/185; H04L 45/586

(57) ABSTRACT

A first network device in a first segment of a network can operate as a rendezvous point (RP) of a multicast protocol. The routing information of the first segment is maintained in a first virtual routing and forwarding (VRF). The first network device can receive source information of a multicast group from a second network device of a second segment of the network. The source information is received based on a second VRF storing routing information of the second segment. The first network device can determine whether to import the source information into the first VRF based on a condition. Upon importing the source information, the first network device can receive a packet of the multicast group from the second network device based on the second VRF. The first network device can forward the packet to a third network device in the first segment based on the first VRF.

### BACKGROUND

A network device, such as a switch, may be deployed in different network topologies. For example, the network device can be deployed in a network with multiple segments (e.g., different sites of an enterprise network). Each of these segments can be under a different administrative domain (e.g., an Autonomous System (AS)) and may maintain its own virtual routing and forwarding (VRF).

### BRIEFDESCRIPTION OF THE FIGURES

FIG. 1 illustrates an example of a network sharing multicast source information and multicast traffic between segments running different VRFs, in accordance with an aspect of the present application.

FIG. 2 illustrates network devices sharing multicast source information between segments running different VRFs based on filtering rules, in accordance with an aspect of the present application.

FIG. 3 presents a flowchart illustrating an example of a process of a network device in a segment obtaining multicast source information and multicast traffic from another segment running a different VRF, in accordance with an aspect of the present application.

FIG. 4 presents a flowchart illustrating an example of a process of a network device in a segment determining a route to a source in a different segment running a different VRF based on obtained multicast source information, in accordance with an aspect of the present application.

FIG. 5 presents a flowchart illustrating an example of a process of a network device in a segment initiating source-path multicast tree (SPMT) establishment to a source in another segment running a different VRF, in accordance with an aspect of the present application.

FIG. 6 illustrates an example of a computing system sharing multicast source information and multicast traffic between segments running different VRFs, in accordance with an aspect of the present application.

FIG. 7 illustrates an example of a computer-readable medium (CRM) facilitating multicast source information and multicast traffic exchange between segments running different VRFs, in accordance with an aspect of the present application.

In the figures, like reference numerals refer to the same figure elements.

### DETAILED DESCRIPTION

Multicast technology plays a crucial role in various Internet applications, allowing efficient content distribution from a single source to multiple hosts through network devices such as switches and routers. This method of data distribution significantly enhances network performance by optimizing bandwidth usage and reducing redundant traffic. To facilitate multicast across a network, network-layer multicast protocols are employed. One commonly used protocol is Protocol-Independent Multicast (PIM), which constructs and maintains multicast distribution trees to ensure efficient content delivery all intended recipients. Hosts wishing to receive traffic from a specific multicast group can initiate the process by sending a client join request to an upstream network device. This join request can be an Internet Group Management Protocol (IGMP) request in Internet Protocol (IP) version 4 (IPv4) networks or a Multicast Listener Discovery (MLD) request in IP version 6 (IPv6) networks. The network device that receives this join request is referred to as the requesting network device.

In a multicast process, the requesting network device can send a network join request (e.g., a PIM join request) to a source network device coupled to the content source of the multicast group. Upon receiving this request, the source network device begins forwarding multicast traffic to the requesting network device, establishing a path for content distribution. The network may include multiple network segments, each segment can be deployed in a site of the network (e.g., different sites of an enterprise network). Different segments of the network may be coupled to each other through corresponding border network devices (or border devices) via an external network (e.g., the Internet). Therefore, control information and data can be forwarded between the segments over the external network.

Typically, a border device of a segment can be responsible for forwarding traffic to and from the segment. If the network includes multiple segments, a source and a requesting host (or a host) of a multicast group can reside in different segments separated by the external network. These segments can be referred to as source and requesting segments, respectively. As a result, the traffic from the source to the host can be forwarded from the source segment to the requesting segment via the external network. Each of these segments can be under a different administrative domain (e.g., an AS). Note that a segment under the management of a particular administrative entity is referred to as a domain, which can maintain its own local (or native) VRF.

The routing protocol, such as the Border Gateway Protocol (BGP), of a segment can exchange control information to establish routes to and from that segment. The routing information produced by running the routing protocol can then be stored in the local VRF and managed by the control plane of the domain. The control messages, such as route advertisements of the routing protocol, can be sent over the control plane. In other words, the control messages can be shared among the network devices deploying the same VRF. Consequently, if different VRFs are deployed in different domains, each domain can run its own control plane, which does not exchange control messages across different domains. Therefore, the routing information in the local VRF of a segment might not be shared with the VRFs of other segments. Corresponding, multicast protocols running on these segments may not share the source information of a multicast group.

The aspects described herein address the problem of sharing multicast source information between VRFs of different segments of a network by (i) extending the source VRF to the rendezvous points (RPs) in other segments and sharing the source information through the extended source VRF; and (ii) importing the source information into the local VRFs from the extended source VRF. The border device of a respective segment can operate as the RP in that segment. Accordingly, the source VRF, which is deployed in the source segment, can be extended to the border devices of other segments. Extending the VRF can include deploying the VRF in the border devices. Subsequently, the source VRF can be used by the multicast protocol to share the source information, such as the IP address of the source and the multicast address of the multicast group. When a border device receives the source information, the border device can import the source information into its local VRF, thereby making the source information available to all other network devices of the segment.

Currently, a network may include a plurality of segments (e.g., different sites of an enterprise network). These segments can be coupled to each other via an overlay network (e.g., a tunnel fabric). Typically, a border device, such as a customer edge (CE) device (e.g., a CE switch), can couple a segment to the external network. Correspondingly, traffic to and from the segment is forwarded by the border device. To forward multicast traffic within and across the segments, the network can run a multicast protocol, such as Protocol Independent Multicast (PIM) sparse-mode (PIM-SM). In a large network, the PIM-SM deployment can include a plurality of RPs. These RPs can run Multicast Source Discovery Protocol (MSDP) to share source information.

During operation, a network device coupling a source of a multicast group can receive multicast traffic of the multicast group. Such a network device can be referred to as a source network device. The source network device can operate as the source-connected designated router (DR) or source DR, which is responsible for forwarding multicast traffic to a requesting network device. The requesting network device can operate as the client-connected DR or client DR, which is responsible for requesting multicast traffic for a multicast group. For a multicast protocol, such as the PIM-SM, the source of a multicast group can register with one of the RPs by sending a registration packet to the RP. This RP can be referred to as the source RP. The source RP can then include the source information in a source advertisement message and send the source advertisement message to the other RPs using MSDP. The source information can include addresses of the source and the multicast group, which can be used to determine routes to the source. Since a VRF corresponds to the control plane over which control messages are exchanged, the source advertisement message can be forwarded to the RPs deploying the source VRF.

Because the source information is now available at a respective RP, a requesting network device can send a network join request to any of the RPs. The RP receiving the network join request can forward it to the source network device. Subsequently, the source network device can determine, based on the network join request, which network device has requested data from the multicast group. The source network device can then forward the multicast traffic to the requesting network devices. Upon receiving the multicast traffic, a requesting network device can forward the multicast traffic to the host. In this way, in a large network, multicast traffic can be distributed based on the plurality of RPs.

However, if the RPs are in different domains (e.g., in different segments), these RPs can be associated with different VRFs. Consequently, MSDP needs to operate among multiple VRFs and hence, across multiple control planes. To facilitate this, network devices in the source domain, which can be deployed in the source segment, deploy all VRFs associated with all other domains of the network. This deployment allows the RP of the source segment to share the source information with other RPs using their respective VRFs. Since each VRF includes a plurality of routing entries programmed in the forwarding hardware, deploying multiple VRFs can strain the hardware resources of the network devices in the source segment. In addition, maintaining the separation of routing information in different domains while deploying multiple VRFs requires extensive and error-prone manual interventions.

To address this issue, the border devices can operate as RPs of the corresponding multicast protocol and deploy the source VRF to facilitate the sharing of the source information. Therefore, the border device of the source segment, which can be referred to as the source border device, can operate as the source RP. The source VRF can be extended to the RPs in other segments that correspond to different domains. Extending the source VRF can include deploying the source VRF in the border devices, which operate as corresponding RPs, in the other segments. As a result, the control plane over which the source information is shared is expanded to the RPs of a respective segment. In other words, the other border devices can participate in the control plane of the source domain. Since the border devices operate as the respective RPs, the source RP can then propagate the source information to the other RPs using MSDP.

To send the source information, the source RP can send the source advertisement message comprising the source information over its control plane. For example, a multicast daemon, which can be a piece of software that facilitates the multicast route establishment and multicast traffic forwarding, can support MSDP on the source border device. When the source RP receives the registration message from a source, the source RP can store the corresponding source information in the source VRF of a routing data structure (e.g., in the memory of the source border device). Here, the source VRF can represent a portion of the routing data structure that stores the routing information associated with the source domain. Using MSDP, the source RP can obtain the source information from the routing data structure, generate the source advertisement message, and include the source information in the source advertisement message. The source RP can send the source advertisement message to other RPs.

Because the RPs in the other segments also deploy the source VRF, the source advertisement message can be forwarded to these RPs. The RP of another segment receives the source advertisement message from the source RP over the source VRF. The RP can then obtain the source information from the source advertisement message and determine whether to import the source information into the local VRF. Here, the local VRF can be distinct from the source VRF since the source segment and the receiving segment may belong to different domains. The local VRF can correspond to the domain of the receiving segment and store routing information associated with the domain of the receiving segment. The RP can apply a filtering rule to determine whether to import the source information. The filtering rule can determine whether a condition to import the source information has been satisfied.

For example, the condition can include a preconfigured policy indicating that source information from a particular source VRF is to be imported or discarded. Similarly, another preconfigured policy can indicate that source information associated with a particular source or multicast group is to be imported or discarded. The condition may also indicate that the source information associated with a source of a multicast group is to be imported if a host requesting the multicast traffic of the multicast group is in the local domain of the segment. Accordingly, the RP can determine whether to import the source information based on a configured policy or the presence of a host in the local domain. When the source information is imported into the local VRF, the RP can determine the shortest-path route to the source. For example, the routing protocol of the segment can determine the route to the IP address of the source. This route can then be included in the local VRF.

To receive the multicast traffic, the client DR in another segment can send a network join request for the multicast group to the RP in that segment. This RP can be referred to as the requesting RP. Since the source VRF is extended to the other RPs, the requesting RP can then forward the join request to the source RP. Before establishing an SPMT, the source typically sends multicast traffic to the source RP. Based on the source VRF, the source RP can forward the multicast traffic to the requesting RP. Furthermore, the local VRF of the requesting RP can include route information associated with the client DR. Accordingly, based on the route information in the local VRF, the requesting RP can send the multicast traffic to the client DR. Subsequently, the client DR can send the multicast traffic to the host.

The border device, which operates as requesting RP, can also send a route advertisement corresponding to the source in its segment. The route advertisement can include route information indicating the route to the source. Based on the route advertisement, other network devices of the segment can determine that the source of the multicast group is reachable via the border device of the segment. Therefore, the network device coupled to the host (i.e., the client DR) can send a control message (or a control packet), such as a source-specific network join request, to the source in accordance with the multicast protocol (e.g., the PIM-SM protocol). The requesting RP can receive the control message and determine the egress port indicated in the route to the source. The requesting RP can then forward the control message to the source DR. Upon receiving the control message, the source DR can start sending the multicast traffic over the shortest path to the client DR, and hence, the distribution of the multicast traffic can converge to the SPMT. In this way, the multicast source information can be shared among segments running different VRFs, which can then lead to efficient distribution of the corresponding multicast traffic.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

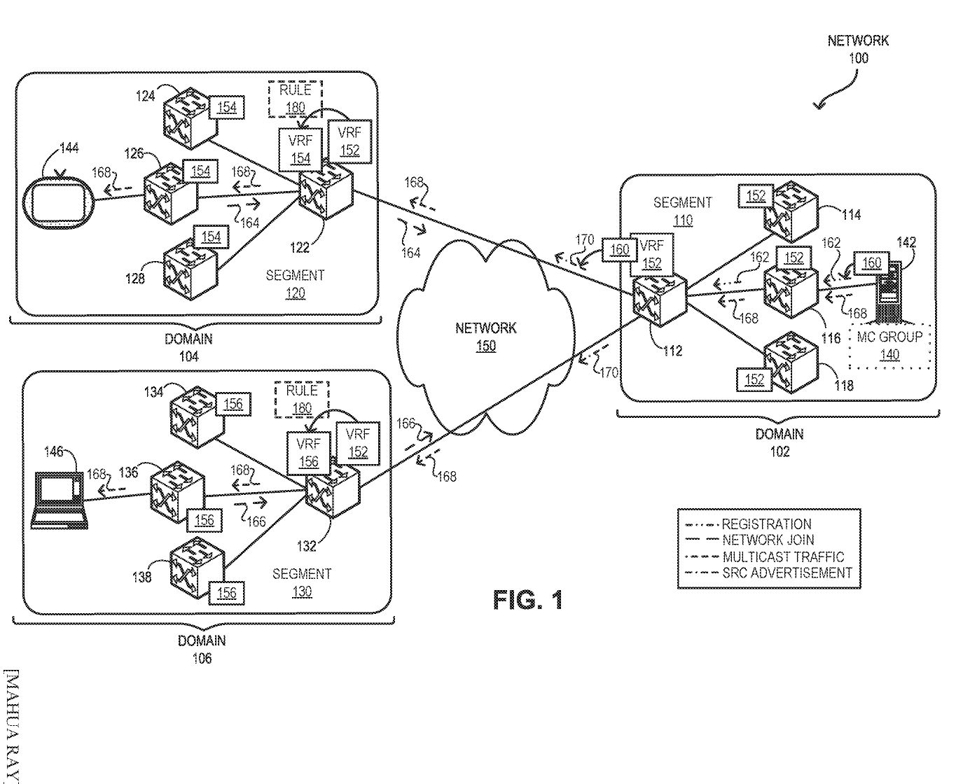

FIG. 1 illustrates an example of a network sharing multicast source information and multicast traffic between segments running different VRFs, in accordance with an aspect of the present application. A network 100 can include a number of network devices (e.g., switches), and may include network components, such as layer-2 and layer-3 hops, and tunnels. In some examples, network 100 can be an Ethernet network, InfiniBand network, or other network, and may use a corresponding communication protocol, such as IP, FibreChannel over Ethernet (FCoE), or other protocols. Network 100 can include segments 110, 120, and 130 coupled to each other via network 150 (e.g., a WAN, such as the Internet). For example, if network 100 is an enterprise network, segments 110, 120, and 130 can correspond to respective sites or departments of the enterprise. In this example, segment 110 can include network devices 112, 114, 116, and 118; segment 120 can include network devices 122, 124, 126, and 128; and segment 130 can include network devices 132, 134, 136, and 138.

A respective network device in network 100 can be associated with a MAC address and an IP address and can include at least one processing resource. Examples of a processing resource can include, but are not limited to, a processor core, a graphics processing unit (GPU), and a tensor processing unit (TPU). Network devices 112, 122, and 132 can couple segments 110, 120, and 130, respectively, to network 150, thereby operating as respective border devices (e.g., CE devices). End devices 142, 144, and 146 can be coupled to network devices 116, 126, and 136, respectively. End device 142 can be the source for multicast group 140 and, hence, can be referred to as source 142. Therefore, multicast traffic 168 (e.g., a stream of multicast packets) of multicast group 140 can be sent from source 142. Network device 116, which can be the source DR, can receive multicast traffic 168 from source 142.

If end devices 144 and 146 request traffic for multicast group 140, they can send respective client join requests (e.g., an IGMP or MLD join) to network devices 126 and 136, respectively, which can be the corresponding client DRs. Therefore, end devices 144 and 146 can also be referred to as hosts 144 and 146, respectively. Border devices 112, 122, and 132 can be responsible for forwarding traffic to and from segments 110, 120, and 130, respectively. In network 100, source 142 can be in segment 110, and hosts 144 and 146 can be in segments 120 and 130, respectively. Therefore, source 142 can be separated from hosts 144 and 146 by network 150. As a result, multicast traffic 168 from source 142 to hosts 144 and 146 can be forwarded through border devices 112, 122, and 132 via network 150. Segments 110, 120, and 130 can be under different domains 102, 104, and 106, respectively. A respective domain can be under an administrative entity (e.g., an AS). Domains 102, 104, and 106 can maintain their own VRFs 152, 154, and 156, respectively. Therefore, VRFs 152, 154, and 156 can be the local VRFs of segments 110, 120, and 103, respectively.

The routing protocol, such as BGP, of segment 110 can exchange control information to establish routes in segment 110. The routes can then be stored in VRF 152 of domain 102. Similarly, the routing protocols of segments 120 and 130 can exchange respective control information to establish routes in segments 120 and 130, respectively. The routes of segments 120 and 130 can then be stored in VRFs 154 and 156, respectively. Therefore, VRFs 152, 154, and 156 can correspond to the control planes of domains 102, 104, and 106, respectively. The control messages of domain 102, such as route advertisements of the routing protocol of segment 110, can be shared over the control plane of domain 102. Here, the control messages can be shared among the network devices deploying VRF 152. Similarly, the control messages in segment 120 can be shared among the network devices deploying VRF 154, and the control messages in segment 130 can be shared among the network devices deploying VRF 156. Since VRFs 152, 154, and 156 are deployed in domains 102, 104, and 106, respectively, each of these domains can run its own control plane. Hence, the control messages from domain 102 are not shared with domains 104 and 106. In other words, the routing information in VRF 152 might not be shared with VRFs 154 and 156.

To distribute multicast traffic in network 100, border devices 112, 122, and 132 can operate the RPs in segments 110, 120, and 130, respectively. Hence, border devices 112, 122, and 132 can also be referred to as RPs 112, 122, and 132, respectively. If network 100 deploys PIM-SM, the RPs in network 100 can run MSDP, which allows RPs 112, 122, and 132 to share the source information of different multicast groups. During operation, source 142 of multicast group 140 can register with RP 112 in segment 110. To do so, source 142 can send a registration message 162 to RP 112. Registration message 162 can include source information 160 comprising respective IP addresses of source 142 and multicast group 140. Based on MSDP, RP 112 can share source information 160 with other RPs of network 100.

However, RPs 112, 122, and 132 are domains 102, 104, and 106, respectively (e.g., in segments 110, 120, and 130, respectively). Here, RPs 112, 122, and 132 can be associated with VRFs 152, 154, and 156, respectively. Consequently, MSDP needs to operate among VRFs 152, 154, and 156 and, hence, across multiple control planes. To facilitate this, network devices 112, 114, 116, and 118 in domain 102 might deploy VRFs 152, 154, and 156. This deployment allows RP 112 to share source information 160 of source 142 with RPs 122 and 132 using VRFs 154 and 156, respectively. Each of VRFs 152, 154, and 156 includes a plurality of routing entries programmed in the forwarding hardware of the network devices of segment 110. Hence, deploying multiple VRFs 152, 154, and 156 can strain the hardware resources of network devices 112, 114, 116, and 118. In addition, maintaining the separation of routing information in domains 102, 104, and 106 while deploying VRFs 152, 154, and 156 requires extensive and error-prone manual interventions.

To address this issue, border devices 112, 122, and 132 can operate as respective RPs and deploy VRF 152 to facilitate the sharing of source information 160. Here, VRF 152 can be extended to RPs 122 and 32 by deploying VRF 152 in the border devices, which operate as corresponding RPs, in the other segments. As a result, the control plane over which source information 160 is shared is expanded to RPs 122 and 132. In other words, border devices 122 and 132 can participate in the control plane of domain 102. RP 112 can then propagate source information 160 to RPs 122 and 132 using MSDP. Using MSDP, RP 112 can obtain source information 160 from VRF 152 and generate source advertisement message 170. RP 112 can source information 160 in source advertisement message 170 and send it to RPs 122 and 132.

Because RPs 122 and 132 also deploy VRF 152, source advertisement message 170 can be forwarded to RPs 122 and 132. Source advertisement message 170 can be forwarded via network 150. Subsequently, RPs 122 and 132 can receive source advertisement message 170 and obtain source information 160 from source advertisement message 170. RPs 122 and 132 can then determine whether to import source information 160 into VRFs 154 and 156, respectively, by applying filtering rule 180. Filtering rule 180 can determine whether a condition to import source information 160 has been satisfied. For example, the condition can include a preconfigured policy indicating that source information from VRF 152 is to be imported or discarded. The condition may also indicate that source information 160 is to be imported if a host requesting the multicast traffic of multicast group 140 is in the local domain.

For example, RPs 122 and 132 can determine whether to import source information 160 based on a configured policy or the presence of a host, such as hosts 144 and 146, respectively. When source information 160 is imported into VRF 154, RP 124 can use the routing protocol of segment 120 to determine the shortest-path route to the IP address of source 142. The route can be included in VRF 154. RP 124 can then send a route advertisement associated with the route in segment 120. Similarly, when source information 160 is imported into VRF 156, RP 126 can determine the shortest-path route to source 142 and include it in VRF 156.

To receive multicast traffic 168, network device 126 (i.e., the client DR associated with host 144) can send a network join request for multicast group 140 to RP 122 in segment 120. For example, if the multicast protocol is PIM-SM, the join request can be a (*, G) join request wherein “*” indicates any source and G corresponds to multicast group 140. Since VRF 152 is extended to RP 122, RP 122 can then forward the join request to RP 122. Before establishing an SPMT, source 142 typically sends multicast traffic 168 to RP 112. Based on VRF 152, RP 112 can forward the multicast traffic to RP 122. Furthermore, VRF 154 of RP 122 can include route information associated with network device 126. Accordingly, based on the route information in VRF 154, RP 122 can send multicast traffic 168 to network device 126. Subsequently, network device 126 can send multicast traffic 168 to host 144.

Border device 122, which operates as RP 122, can also send a route advertisement corresponding to source 142 in segment 120. The route advertisement can include route information indicating the route to source 142. Based on the route advertisement in segment 120, network device 126 can determine that source 142 is reachable via border device 122. In accordance with the multicast protocol, network device 126 can send a control message, which can be a source-specific network join request 164, to border device 122 for source 142. For example, if the multicast protocol is PIM-SM, join request 164 can be a (S, G) join request wherein S corresponds to source 142 and G corresponds to multicast group 140. Therefore, join request 164 can include the respective IP addresses of source 142 and multicast group 140. Border device 122 can receive join request 164 and determine the egress port indicated in the route to source 142. Border device 122 can then forward join request 164 to network device 116 (i.e., the source DR) via the egress port. Similarly, based on the route advertisements in segment 130, network device 136 can determine that source 142 is reachable via border device 132 and send source-specific network join request 166 to source 142 through border device 132.

Upon receiving join request 164, network device 116, which can be the source DR associated with source 142, can start sending multicast traffic 168 over the shortest path to network device 126, which is the corresponding client DR. In the same way, upon receiving join request 166, network device 116 can start sending multicast traffic 168 over the shortest path to network device 136. Multicast traffic 168 can then be forwarded via border device 112 through network 150 to border devices 122 and 132. Subsequently, border device 122 can forward multicast traffic 168 to network device 126, which can then send it to host 144. Border device 132 can forward multicast traffic 168 to network device 136, which can then send it to host 146. Therefore, the distribution of multicast traffic 168 can converge to the SPMT associated with multicast group 140. In this way, source information 160 can be shared among segments 110, 120, and 130 running different VRFs, which can then lead to efficient distribution of corresponding multicast traffic 168.

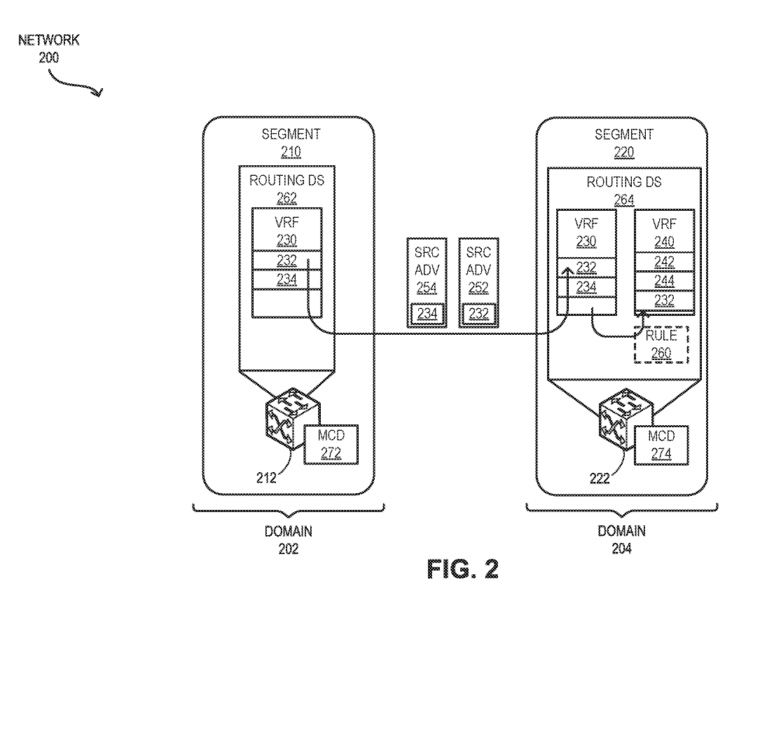

FIG. 2 illustrates network devices sharing multicast source information between segments running different VRFs based on filtering rules, in accordance with an aspect of the present application. A network 200 can include a number of network devices (e.g., switches), and may include network components, such as layer-2 and layer-3 hops, and tunnels. In some examples, network 200 can be an Ethernet network, InfiniBand network, or other network and may use a corresponding communication protocol, such as IP, FCoE, or other protocols. Network 200 can include segments 210 and 220 coupled to each other via an external network (e.g., a WAN, such as the Internet). For example, if network 200 is an enterprise network, segments 210 and 220 can correspond to respective sites or departments of the enterprise. In this example, segment 210 can include a number of network devices, such as network device 212, and segment 220 can include a number of network devices, such as network device 222.

A respective network device in network 200 can be associated with a MAC address and an IP address and can include at least one processing resource. Examples of a processing resource can include, but are not limited to, a processor core, a GPU, and a TPU. Network devices 212 and 222 can couple segments 210 and 220, respectively, to the external network, thereby operating as respective border devices (e.g., CE devices). Segments 210 and 220 can be under different domains 202 and 204, respectively. A respective domain can be under an administrative entity (e.g., an AS). Domains 202 and 204 can maintain their own VRFs 230 and 240, respectively. Therefore, VRFs 230 and 240 can be the local VRFs of segments 202 and 204, respectively. One or more end devices can be coupled to networks 210 and 220. In this example, domain 202 and segment 210 can be the source domain and the source segment, respectively. The routing protocols of segments 210 and 220 can exchange respective control information to establish routes in segments 210 and 220, respectively. The routes of segments 210 and 220 can then be stored in VRFs 230 and 240, respectively. Therefore, VRFs 230 and 240 can correspond to the control planes of domains 202 and 204, respectively.

Border devices 212 and 222 can operate as respective RPs of segments 210 and 220, respectively. Therefore, border devices 212 and 222 can be referred to as RPs 212 and 222, respectively. If network 200 deploys PIM-SM, the RPs in network 200 can run MSDP, which allows RPs 212 and 222 to share the source information of different multicast groups. If segment 210 is the source segment for one or more multicast groups, the sources of these multicast groups can register with RPs 212 in segment 210. To do so, the sources can send respective registration messages to RP 212. These registration messages can include source information 232 and 234 comprising respective IP addresses of the sources and the multicast groups. Based on MSDP, RP 212 can share source information 232 and 234 with other RPs of network 200.

Since RPs 212 and 222 are associated with different VRFs, source VRF 230 can be extended to RP 222 in segment 220, which corresponds to domain 204. Extending VRF 230 can include deploying VRF 230 RP 222. As a result, the control plane over which source information 232 and 234 can be shared is expanded to RP 222. In other words, RP 222 can participate in the control plane of domain 202. As a result, RP 212 can then propagate source information 232 and 234 to RP 222 using MSDP. To send source information 232, RP can send source advertisement message 252 comprising source information 232 over its control plane. For example, RP 212 can run a multicast daemon 272, which can be a piece of software that facilitates the multicast route establishment and multicast traffic forwarding on RP 212. RP 222 can also run a multicast daemon 274, which can be a piece of software that facilitates the multicast route establishment and multicast traffic forwarding on RP 222. Therefore, MSDP can be supported by multicast demons 272 and 274 on RPs 212 and 222, respectively.

When RP 212 receives the registration message comprising source information 232 from a source, RP 212 can store source information 232 in VRF 230 of a routing data structure 262 of RP 212. Routing data structure 262 can be stored in the memory of RP 212. Here, VRF 230 can represent a portion of routing data structure 262 that stores the routing information associated with domain 202. Using MSDP, RP 212 can obtain source information 232 from VRF 230 in routing data structure 262, generate source advertisement message 252, and include source information 232 in source advertisement message 252. RP 212 can then send source advertisement message 252 to RP 222. Similarly, the source of another multicast group can provide source information 234 to RP 212, which can then store source information 234 in VRF 230. Using MSDP, RP 212 can obtain source information 234 from VRF 230 in routing data structure 262, generate source advertisement message 254, and include source information 234 in source advertisement message 254. RP 212 can then send source advertisement message 254 to RP 222.

Because RP 222 also deploys VRF 230, source advertisement messages 252 and 254 can be forwarded to RP 222. RP 222 can receive source advertisement messages 252 and source advertisement messages 254 from RP 212 in association with VRF 230. Therefore, RP 222 can store source information 232 and 234 in VRF 230 in routing data structure 264 of RP 222. Routing data structure 264 can be stored in the memory of RP 222. Routing data structure 264 can also include another VRF 240, which can be the local VRF of segment 220. Here, VRF 240 can represent a portion of routing data structure 264 that stores the routing information associated with domain 204. For example, VRF 240 can store routing information 242 and 244, which can be generated by a routing protocol (e.g., BGP) deployed in segment 220. Routing information 242 and 244 can indicate the shortest-path routes to one or more devices of segment 220.

RP 222 can then obtain source information 232 and 234 from VRF 230 and determine whether to import source information 232 and 234 into VRF 240. It should be noted that VRF 240 can be distinct from VRF 230 because segments 210 and 220 belong to domains 202 and 204, respectively. To determine whether to import source information 232 and 234 into VRF 240, RP 222 can apply a filtering rule 260 to determine whether to import source information 232 and 234. Filtering rule 260 can determine whether a condition to import source information 232 and 234 has been satisfied. For example, the condition can include a preconfigured policy indicating that source information from a particular source VRF, such as VRF 230, is to be imported or discarded. Similarly, another preconfigured policy of rule 260 can indicate that source information associated with a particular source or multicast group is to be imported or discarded. The condition may also indicate that source information 232 and 234 is to be imported into VRF 240 if a host requesting the multicast traffic of a corresponding multicast group is in domain 204 of segment 220.

Accordingly, RP 222 can determine whether to import source information 232 and 234 into VRF 240 based on a configured policy or the presence of a host in segment 220. In this example, RP 222 may determine that source information 232 specifies a source of a multicast group and a host requested multicast traffic of that multicast group. Therefore, based on the satisfaction of the condition in rule 260, RP 222 can import source information 232 into VRF 240. On the other hand, RP 222 may determine that source information 234 is associated with a multicast group for which no host has requested multicast traffic. Therefore, based on rule 260, RP 222 can refrain from importing source information 234 into VRF 240. When source information 232 is imported into VRF 240, RP 222 can determine the shortest-path route to the source indicated in source information 232. For example, the routing protocol of segment 220 can determine the route to the IP address of the source. This route can then be included in VRF 240. A route advertisement associated with the route information can then be distributed in segment 220 from border device 212.

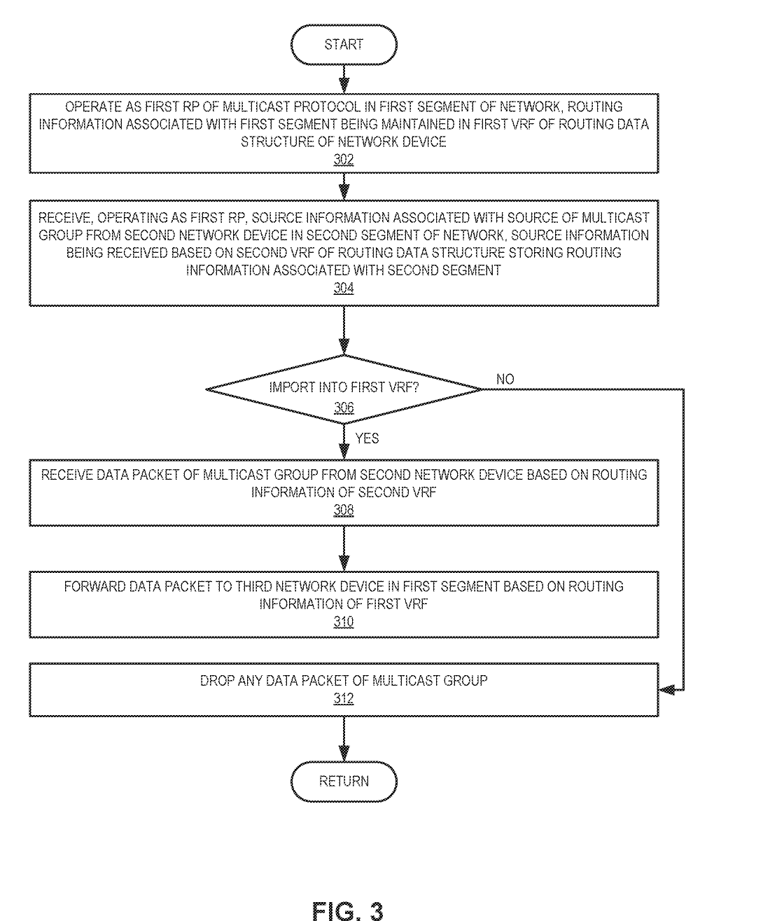

FIG. 3 presents a flowchart illustrating an example of a process of a network device in a segment obtaining multicast source information and multicast traffic from another segment running a different VRF, in accordance with an aspect of the present application. During operation, the network device can operate as a first RP of a multicast protocol in a first segment of a network (operation 302). Here, the routing information associated with the first segment can be maintained in a first VRF of a routing data structure of the network device. For example, the network device can operate as the first RP of the PIM-SM protocol. The network device can then receive, operating as the first RP, the source information associated with the source of a multicast group from a second network device in a second segment of the network (operation 304). The source information can be received based on a second VRF of the routing data structure storing routing information associated with the second segment. Here, the second VRF can be the source VRF that has been extended to the network device. Therefore, the second network device can be the source RP of the multicast group. As a result, the network device can receive the source information based on the second VRF. I

The network device can determine whether to import the source information into the first VRF (operation 306). The network device can apply a filtering rule to determine whether to import the source information. The filtering rule can determine whether a condition to import the source information has been satisfied. If the source information is imported into the first VRF, the network device can receive a data packet of the multicast group from the second network device based on the routing information of the second VRF (operation 308). A source typically sends multicast traffic to the source RP, which can be the second network device. Based on the second VRF (e.g., the source VRF), the second network can forward the multicast traffic to the network device.

The network device can then forward the data packet to a third network device in the first segment based on the routing information of the first VRF (operation 310). Here, the third network device can be the client DR coupled to a host. The third network device can send a join request (e.g., a PIM join) to the network device requesting multicast traffic of the multicast group. Accordingly, the network device can forward the data packet to the third network device. On the other hand, if the source information is not imported into the first VRF, the network device can drop any data packet of the multicast group (operation 312). Since the source information is not imported into the first VRF, there may not be a host in the first segment requesting the multicast traffic. As a result, the network device may not forward any data packet into the first segment. In the example in FIG. 1, RP 122 can determine whether to import source information 160 into VRF 154 based on rule 180. Upon importing the source information, RP 122 can receive multicast traffic 168 from RP 112 and forward it to network device 126.

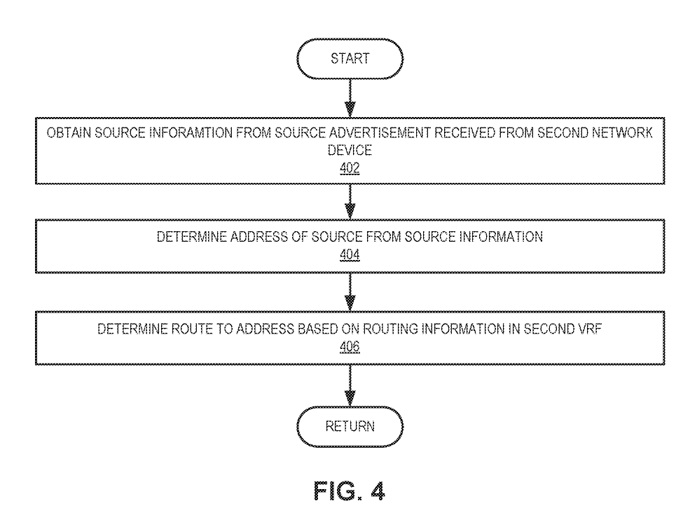

FIG. 4 presents a flowchart illustrating an example of a process of a network device in a segment determining a route to a source in a different segment running a different VRF based on obtained multicast source information, in accordance with an aspect of the present application. During operation, the network device can obtain the source information from a source advertisement received from the second network device (operation 402). In this example, the network device and the second network device correspond to the network device and the second network device of FIG. 3. When the source of the multicast group registers with the second network device, which operates as the source RP, the second network device can include the source information in the source advertisement and send it to the network device.

The source information can include respective IP addresses of the source and the multicast group. The network device can determine the address of the source from the source information (operation 404). Since the source information includes the IP address of the source, the network device can determine the source’s address. Subsequently, the network device can determine a route to the address based on the routing information in the second VRF (operation 406). Because the second VRF corresponds to the second segment of the network, the second VRF can include routing information associated with the second segment. Accordingly, the network device can determine a route to the source. In the example in FIG. 1, RP 122 can determine the address of source 142 from source information 160 in source advertisement message 170 and determine a route to source 142 based on VRF 152.

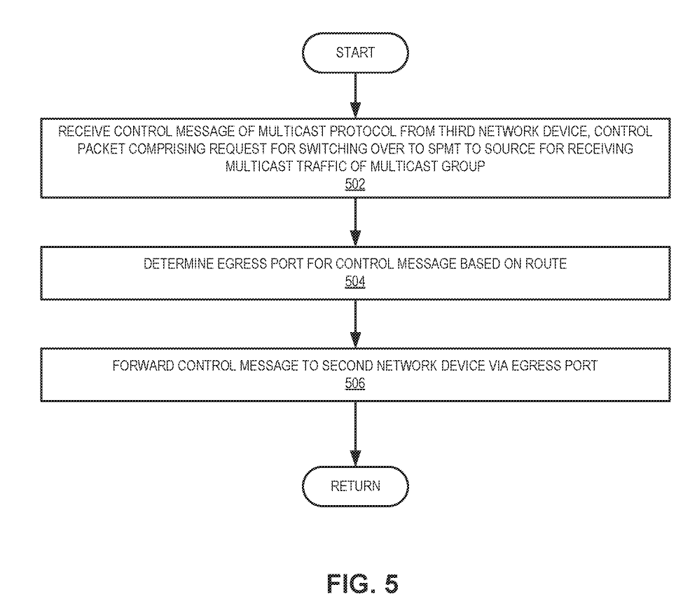

FIG. 5 presents a flowchart illustrating an example of a process of a network device in a segment initiating SPMT establishment to a source in another segment running a different VRF, in accordance with an aspect of the present application. During operation, the network device can receive a control message of the multicast protocol from the third network device (operation 502). Here, the network device and the third network device can correspond to the network device and the third network device of FIG. 3. The control packet can comprise a request for switching over to the SPMT to the source for receiving multicast traffic of the multicast group. The control message can be a source-specific network join request to the source in accordance with the multicast protocol (e.g., the PIM-SM protocol).

The network device can determine an egress port for the control message based on the route (operation 504). Typically, when a route to a target device is determined, the route indicates a corresponding next-hop device and the port coupled to that next-hop device. Therefore, the target device can be reachable via the port. Therefore, the network device can determine the port indicated in the route to the source as the egress port for the control message. The network device can then forward the control message to the second network device via the egress port (operation 506). Consequently, the source can receive the control message and start sending the multicast traffic to the third network device over the SPMT. In the example in FIG. 1, border device 122 can receive join request 164 from network device 126, determine an egress port based on the route to source 142, and forward join request 164 to source 142 via the egress port.

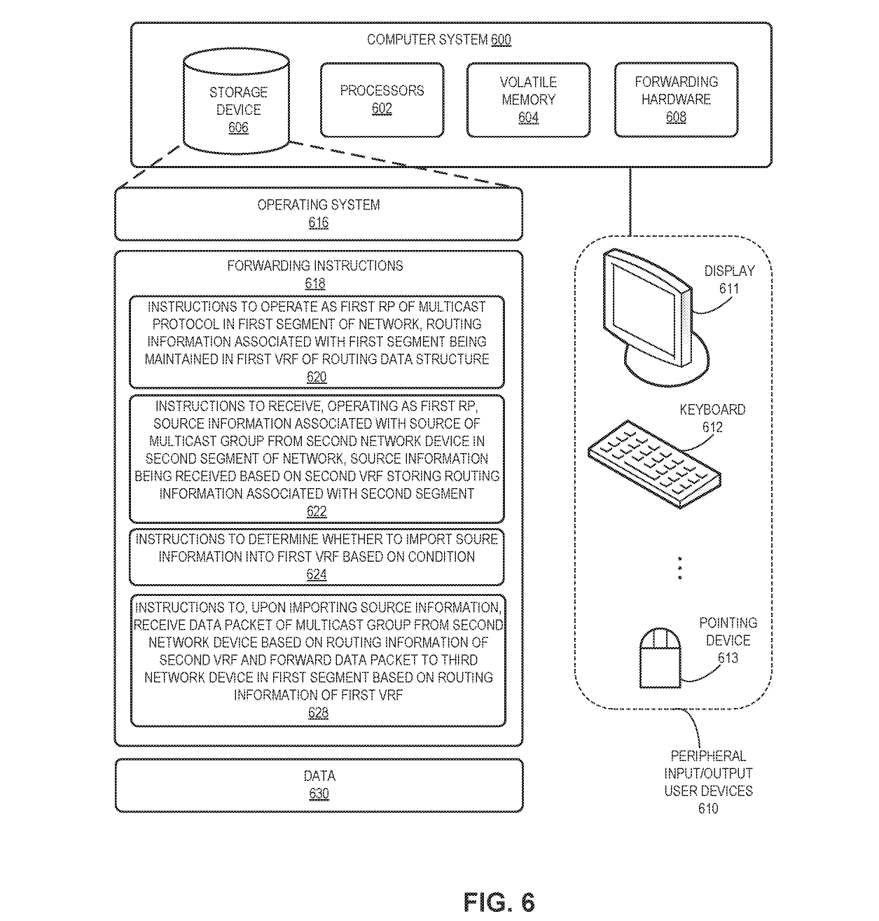

FIG. 6 illustrates an example of a computing system sharing multicast source information and multicast traffic between segments running different VRFs, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a Ternary Content Addressable Memory (TCAM). Storage device 606 includes a non-transitory computer-readable storage medium and stores an operating system 616, forwarding instructions 618, and data 630. Computer system 600 may include fewer or more entities or instructions than those shown in FIG. 6.

Forwarding instructions 618 can include instructions, which when executed by computer system 600, can cause computer system 600 to perform methods and/or processes described in this disclosure. Forwarding instructions 618 can be executed on at least one of processors 602, forwarding hardware 608, or a combination thereof. Computer system 600 can be a network device, such as network device 122 in FIG. 1 and network device 222 in FIG. 2. Specifically, forwarding instructions 618 may include instructions 620 to operate as a first RP of a multicast protocol in a first segment of a network. Here, the routing information associated with the first segment can be maintained in a first VRF of a routing data structure of computer system 600.

Forwarding instructions 618 may also include instructions 622 to receive, operating as the first RP, the source information associated with the source of a multicast group from a second network device in a second segment of the network. The source information can be received based on a second VRF storing routing information associated with the second segment. Furthermore, forwarding instructions 618 may also include instructions 624 to determine whether to import the source information into the first VRF. Computer system 600 can apply a filtering rule to determine whether to import the source information. Forwarding instructions 618 may include instructions 626 to, upon importing the source information, receive a data packet of the multicast group from the second network device based on the routing information of the second VRF and forward the data packet to a third network device in the first segment based on the routing information of the first VRF. Here, the third network device can be the client DR coupled to a host.

Data 630 can include any data that is required as input, or that is generated as output by the methods, operations, communications, and/or processes described in this disclosure. Specifically, data 630 can include routing information of a respective VRF of the network (e.g., routing information 242 and 244 in FIG. 2) and source information in a respective VRF of the network (e.g., source information 232 and 234 in FIG. 2). Data 630 can also include a rule based on which computer system 600 can determine whether to import source information into a VRF (e.g., rule 260 in FIG. 2).

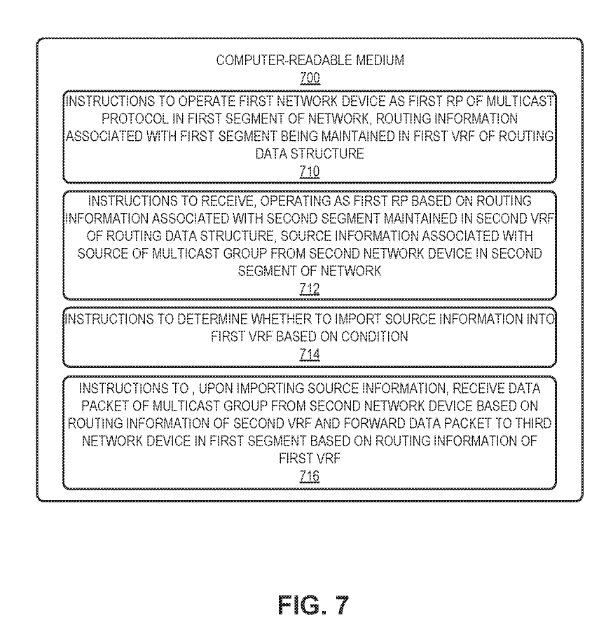

Computer system 600 and forwarding instructions 618 may include more instructions than those shown in FIG. 6. For example, forwarding instructions 618 can also store instructions for obtaining source information 160 from registration message 162 and storing it in VRF 152 of FIG. 1; incorporating source information 160 into source advertisement message 170 of FIG. 1; sending join request 164 to source 142 of FIG. 1; refraining from importing source information 234 into VRF 240 of FIG. 2; maintaining a plurality of VRFs in routing data structure 264 of FIG. 2; the operations depicted in the flowcharts of FIGS. 3, 4, and 5; and the instructions of non-transitory CRM 700 in FIG. 7.

FIG. 7 illustrates an example of a CRM facilitating multicast source information and multicast traffic exchange between segments running different VRFs, in accordance with an aspect of the present application. CRM 700 can include one or more non-transitory computer-readable mediums or devices storing instructions that, when executed by a computer or processor, cause the computer or processor to perform a method. Therefore, the instructions in CRM 700 can be stored in one or more non-transitory computer-readable mediums or devices. CRM 700 can store instructions 710 to operate a first network device as a first RP of a multicast protocol in a first segment of a network. Here, the routing information associated with the first segment can be maintained in a first VRF of a routing data structure of the first network device.

CRM 700 can also include instructions 712 to receive, operating as the first RP, the source information associated with the source of a multicast group from a second network device in a second segment of the network. The source information can be received based on a second VRF storing routing information associated with the second segment. CRM 700 can include instructions 714 to determine whether to import the source information into the first VRF. CRM 700 can also include instructions 716 to, upon importing the source information, receive a data packet of the multicast group from the second network device based on the routing information of the second VRF and forward the data packet to a third network device in the first segment based on the routing information of the first VRF. Here, the third network device can be the client DR coupled to a host.

CRM 700 may include more instructions than those shown in FIG. 7. For example, CRM 700 can also store instructions for obtaining source information 160 from registration message 162 and storing it in VRF 152 of FIG. 1; incorporating source information 160 into source advertisement message 170 of FIG. 1; sending join request 164 to source 142 of FIG. 1; refraining from importing source information 234 into VRF 240 of FIG. 2; maintaining a plurality of VRFs in routing data structure 264 of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a first network device in a first segment of a network. During operation, the first network device can operate as a first RP of a multicast protocol. The routing information associated with the first segment can be maintained in a first VRF of a routing data structure of the first network device. The first network device can receive, operating as the first RP, source information associated with a source of a multicast group from a second network device of a second segment of the network. The source information can be received based on a second VRF of the routing data structure storing routing information associated with the second segment. The first network device can determine whether to import the source information into the first VRF based on a condition. Upon importing the source information into the first VRF, the first network device can receive a data packet of the multicast group from the second network device based on the routing information of the second VRF. The first network device can then forward the data packet to a third network device in the first segment based on the routing information of the first VRF. Here, a host associated with the multicast group is coupled to the third network device.

In a variation on this aspect, the first network device can forward a control message of the multicast protocol to the second network device. The control message can include a request for switching over to an SPMT to the source for receiving multicast traffic of the multicast group.

In a further variation, the first network device can receive the control message from the third network device and determine an egress port for the control message based on the route.

In a variation on this aspect, the first network device can determine an address of the source based on the source information and determine a route to the address based on the routing information in the second VRF.

In a variation on this aspect, the second network device can operate as a second RP of the multicast protocol.

In a variation on this aspect, the condition can include one or more of: whether the first VRF is allowed to import a route determined based on the first VRF, and whether a host requesting traffic of the multicast group is coupled to the first segment.

In a variation on this aspect, the multicast protocol can include a PIM-SM protocol. The source information can then be received based on MSDP.

In a variation on this aspect, if the source information is not imported into the first VRF, the first network device can drop the data packet.

In a variation on this aspect, a respective segment can correspond to an AS of the network.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
operating, in a first segment of a network, a first network device as a first rendezvous point (RP) of a multicast protocol, wherein routing information associated with the first segment is maintained in a first virtual routing and forwarding (VRF) of a routing data structure of the first network device;
receiving, by the first network device operating as the first RP, source information associated with a source of a multicast group from a second network device of a second segment of the network, wherein the source information is received based on a second VRF of the routing data structure storing routing information associated with the second segment;
determining whether to import the source information into the first VRF based on a condition; and
in response to importing the source information into the first VRF:
receiving a data packet of the multicast group from the second network device based on the routing information of the second VRF; and
forwarding the data packet to a third network device in the first segment based on the routing information of the first VRF, wherein a host associated with the multicast group is coupled to the third network device.

2. The method of claim 1, further comprising forwarding a control message of the multicast protocol to the second network device, wherein the control message includes a request for switching over to a shortest-path multicast tree (SPMT) to the source for receiving multicast traffic of the multicast group.

3. The method of claim 2, further comprising:
receiving the control message from the third network device; and
determining an egress port for the control message based on the route.

4. The method of claim 1, further comprising:
determining an address of the source based on the source information; and
determining a route to the address based on the routing information in the second VRF.

5. The method of claim 1, wherein the second network device operates as a second RP of the multicast protocol.

6. The method of claim 1, wherein the condition comprises one or more of:
whether the first VRF is allowed to import a route determined based on the first VRF; and
whether a host requesting traffic of the multicast group is coupled to the first segment.

7. The method of claim 1, wherein the multicast protocol includes a Protocol Independent Multicast (PIM) sparse-mode (PIM-SM) protocol, and wherein the source information is received based on a Multicast Source Discovery Protocol (MSDP).

8. The method of claim 1, wherein, in response to not importing the source information into the first VRF, the method further comprises dropping the data packet.

9. The method of claim 1, wherein a respective segment corresponds to an autonomous system (AS) of the network.

10. A non-transitory computer-readable storage medium storing instructions to:
operate, in a first segment of a network, a first network device as a first rendezvous point (RP) of a multicast protocol, wherein routing information associated with the first segment is maintained in a first virtual routing and forwarding (VRF) of a routing data structure of the first network device;
receive, by the first network device operating as the first RP, source information associated with a source of a multicast group from a second network device of a second segment of the network, wherein the source information is received based on a second VRF of the routing data structure storing routing information associated with the second segment;
determine whether to import the source information into the first VRF based on a condition; and
in response to importing the source information into the first VRF:
receive a data packet of the multicast group from the second network device based on the routing information of the second VRF; and
forward the data packet to a third network device in the first segment based on the routing information of the first VRF, wherein a host associated with the multicast group is coupled to the third network device.

11. The non-transitory computer-readable storage medium of claim 10, wherein the instructions are further to forward a control message of the multicast protocol to the second network device, wherein the control message includes a request for switching over to a shortest-path multicast tree (SPMT) to the source for receiving multicast traffic of the multicast group.

12. The non-transitory computer-readable storage medium of claim 11, wherein the instructions are further to:
receive the control message from the third network device; and
determine an egress port for the control message based on the route.

13. The non-transitory computer-readable storage medium of claim 10, wherein the instructions are further to:
determine an address of the source based on the source information; and
determine a route to the address based on the routing information in the second VRF.

14. The non-transitory computer-readable storage medium of claim 10, wherein the second network device operates as a second RP of the multicast protocol.

15. The non-transitory computer-readable storage medium of claim 10, wherein the condition comprises one or more of:
whether the first VRF is allowed to import a route determined based on the first VRF; and
whether a host requesting traffic of the multicast group is coupled to the first segment.

16. The non-transitory computer-readable storage medium of claim 10, wherein the multicast protocol includes a Protocol Independent Multicast (PIM) sparse-mode (PIM-SM) protocol, and wherein the source information is received based on a Multicast Source Discovery Protocol (MSDP).

17. The non-transitory computer-readable storage medium of claim 10, wherein, in response to not importing the source information into the first VRF, the instructions are further to drop the data packet.

18. The non-transitory computer-readable storage medium of claim 10, wherein a respective segment corresponds to an autonomous system (AS) of the network.

19. A computer system, comprising:
at least one processing resource;
forwarding hardware; and
a non-transitory computer-readable storage medium storing instructions that when executed by the processing resource cause the computer system to:
operate, in a first segment of a network, as a first rendezvous point (RP) of a multicast protocol, wherein routing information associated with the first segment is maintained in a first virtual routing and forwarding (VRF) of a routing data structure of the computer system;
receive, operating as the first RP, source information associated with a source of a multicast group from a second network device of a second segment of the network, wherein the source information is received based on a second VRF of the routing data structure storing routing information associated with the second segment;
determine whether to import the source information into the first VRF based on a condition; and
in response to importing the source information into the first VRF:
receive a data packet of the multicast group from the second network device based on the routing information of the second VRF; and
forward the data packet to a third network device in the first segment based on the routing information of the first VRF, wherein a host associated with the multicast group is coupled to the third network device.

20. The computer system of claim 19, wherein the instructions that when executed by the processing resource cause the computer system to:
receive a control message of the multicast protocol from the third network device, wherein the control message includes a request for switching over to a shortest-path multicast tree (SPMT) to the source for receiving multicast traffic of the multicast group; and
forward the control message to the second network device.
